(19) United States
(12) Patent Application Publication
(10) Pub. No.: US 2015/0152946 A1
(43) Pub. Date: Jun. 4, 2015

(54) BALL SCREW ASSEMBLY

(71) Applicant: Nook Industries, Inc., Cleveland, OH (US)

(72) Inventors: Daniel J. PILTZ, Ravenna, OH (US); Alexander S. MARGOLIN, Solon, OH (US); Steven J. DENNEY, Parma Heights, OH (US); Joseph H. NOOK, III, Munson, OH (US)

(21) Appl. No.: 14/096,506

(22) Filed: Dec. 4, 2013

(51) Int. Cl. F16H 25/22

(52) U.S. Cl. CPC F16H 25/2214

(57) ABSTRACT

A ball screw assembly having a bearing ball recirculation arrangement. The ball screw assembly includes a ball screw, a nut body, at least one cap, and at least two yolk deflectors. The assembly may include a set of bearing balls disposed between the ball screw and the nut body in a load bearing path. The two yolk deflectors may each define a surface to engage bearing balls exiting or entering a return path.

### BACKGROUND

Certain mechanical assemblies are designed to translate rotary motion into linear motion, such as for example, a ball screw assembly, which is a well-known arrangement offering relatively high efficient and low friction. A typical ball screw assembly has a number of bearing balls that transfer the load between the screw and the nut, while the nut moves linearly relative the longitudinal axis of the screw. In a common arrangement, one of either the screw or the nut rotate while the other is held stationary, depending on among other things, the application of the ball screw. In operation, the bearing balls travel around the screw within the threads, and migrate toward a distal end of the ball screw assembly. A typical ball screw assembly is a closed mechanism, and thus, must include a recirculation arrangement to deflect the bearing balls out of a ball nut and a ball screw, and return them to the start of the ball circuit to allow the bearing balls to re-enter the load bearing path.

Examples of typical ball screw returns include external returns and internal returns. These two types of returns are generally designed and manufactured uniquely for each ball screw assembly based on application requirements, e.g., ball screw diameter, screw pitch, ball screw lead, ball diameter, and screws starts, i.e., independent threads of the shaft. In other words, each type of return offers little to no efficiencies in design, manufacturing, or inventory over multiple applications. i.e., a variety of different applications.

A prior art ball screw assembly 10 having an exemplary external return is illustrated in FIGS. 1-3. The assembly 10 includes a nut body 14 positioned co-axially on a screw shaft 12 and, in application, prohibited from rotational movement by structure (not shown). The nut 14 moves linearly along the longitudinal axis L₁ of the screw 12 (see FIG. 2). An external tube 16 provides a return path for bearing balls 22 from a nut exit 24 to a nut input 26. As known in the art, either passage 24, 26 may act as a nut exit or a nut input, depending on the rotational direction of the screw. The tube 16 is secured to the nut 14 by a bracket 18 and mechanical fasteners 20. FIG. 3 is a cross-sectional view along the axis of the tube 16. It should be understood that other external return ball screw returns exist with one or more similar features.

A prior art exemplary internal return is illustrated in FIGS. 4-6. A ball screw assembly 30 includes a nut body 34 positioned on a screw shaft 32 and; in application, prohibited from rotational movement by structure (not shown). Threads on the exterior of the shaft define a helical pattern along its length. The nut 34 moves linearly along the longitudinal axis L₂ of the screw 32 (see FIG. 5). An insert 36, or referred to as a multi-liner in the art, is positioned between the shaft and the nut along the length of the nut. The insert 36 includes a plurality of separate return paths 38 in which the travel path of a ball 40 about the circumference of shaft 32 is adjusted, such that the balls do not travel along the length of the shaft, not individually, collectively or in sets. In other words, the balls are divided into groups and travel within a separate path circumferentially around the screw, i.e., in a single path of a plurality of paths. It should be understood that other internal return ball screw returns exist with one or more similar features.

### SUMMARY

The present application describes a ball screw assembly having a bearing ball recirculation arrangement.

In an exemplary embodiment, the ball screw assembly includes a ball screw, a nut body in threaded engagement with the ball screw, at least one set of bearing balls disposed between the ball screw and the nut body in a load bearing path, at least one cap having a recessed channel at least partially defining a return path for bearing balls from one end of the load bearing path to another end of the load bearing path, and at least two yolk deflectors. One of the ball screw and the nut body is rotationally fixed relative the other. One of the two yolk deflectors may define a deflecting surface to engage bearing balls exiting or entering the return path.

### BRIEF DESCRIPTION OF THE DRAWINGS

Features and advantages of the general inventive concepts will become apparent from the following detailed description made with reference to the accompanying drawings.

FIG. 1 is a perspective view of a prior art ball screw assembly having an external ball return;

FIG. 2 is a cross-sectional view of the ball screw assembly of FIG. 1, shown along a longitudinal axis of the screw;

FIG. 3 is a cross-sectional view of the ball screw assembly of FIG. 1, shown along a longitudinal axis of the return tube;

FIG. 4 is a perspective view of a prior art ball screw assembly having an internal ball return;

FIG. 5 is a cross-sectional view of the ball screw assembly of FIG. 4, shown along a longitudinal axis of the screw;

FIG. 6 is a cross-sectional view of the ball screw assembly of FIG. 4, shown along a longitudinal axis of the ball nut body and with the screw removed;

FIG. 7 is a perspective view of an exemplary embodiment of a ball screw assembly having yoke deflectors;

FIG. 8 is a partially exploded assembly view of the ball screw assembly of FIG. 7;

FIG. 9 is a partially exploded cross-sectional assembly view of the ball screw assembly of FIG. 7, shown along a longitudinal axis of the screw;

FIG. 10 is a perspective cross-sectional view of the ball nut body of FIG. 7, shown along a longitudinal axis of the ball nut body and with three ball bearing sets installed;

FIG. 11 is a perspective partially exploded assembly view of the ball screw assembly of FIG. 7, shown with the screw, cap and two yoke deflectors removed;

FIG. 12 is a top view of the ball screw assembly of FIG. 7, shown with the screw, cap and two yoke deflectors removed;

FIG. 13 is a cross-sectional view of the ball screw assembly of FIG. 7, shown along the lines 13-13 of FIG. 12;

FIG. 14 is a cross-sectional view of the ball screw assembly of FIG. 7, shown along the lines 14-14 of FIG. 12;

FIG. 15 is a perspective view of the ball screw assembly of FIG. 7, showing only a center set of bearing balls and the yoke deflectors;

FIG. 16 is a front view of the ball screw assembly of FIG. 7, showing only a center set of bearing balls and the yoke deflectors;

FIG. 17 is a top view of the ball screw assembly of FIG. 7, shown with the screw, cap and two yoke deflectors removed;

FIG. 18 is a bottom perspective view of the cap of FIG. 7;

FIG. 19 is a bottom view of the cap of FIG. 18;

FIG. 20 is a front view of a yoke deflector of FIG. 7;

FIG. 21 is a top view of the yoke deflector of FIG. 20;

FIG. 22 is a right side view of the yoke deflector of FIG. 20; and

FIG. 23 is a bottom view of the yoke deflector of FIG. 20.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than an unlimited by the exemplary embodiments set forth herein, and the terms used in the claims have their full ordinary meaning.

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular pressure source, reaction conditions, and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

When the term path is used in this specification or in the claims, the term is used in reference to path of travel of ball bearings. When the terms vertical or horizontal are used in this specification or in the claims, the terms are used with respect to the position of the ball screw, and the position of the ball screw along its longitudinal axis being generally horizontal.

The present invention relates to a ball screw assembly having recirculation features to generally transfer balls from the load bearing path of the ball screw to a return path, and to generally transition the balls along the return path back to the start of the circuit, i.e., the start of the load bearing path. An inventive assembly and method utilizes an engagement, or deflecting, feature, such as for example, a surface of a yolk deflector, at the end of the load path, and at the end of the return path. The surface may be concave to engage a round ball bearing.

The present invention includes a yolk deflector which may be seated relative to the ball nut body at either end of a return path. The path is defined by an elongated recess in either or both of a cap and a ball nut body. Recesses in the cap and a ball nut body may align with each other. The yolk deflector may guide the travel of balls into the return path at a path entrance and out of the return path at a path exit. The use of the yolk deflector and cap with a particular ball diameter may offer flexibility across different ball screw diameters, length and lead variations, and the need for specially designed and manufactured return (recirculation) devices for each particular application may be reduced.

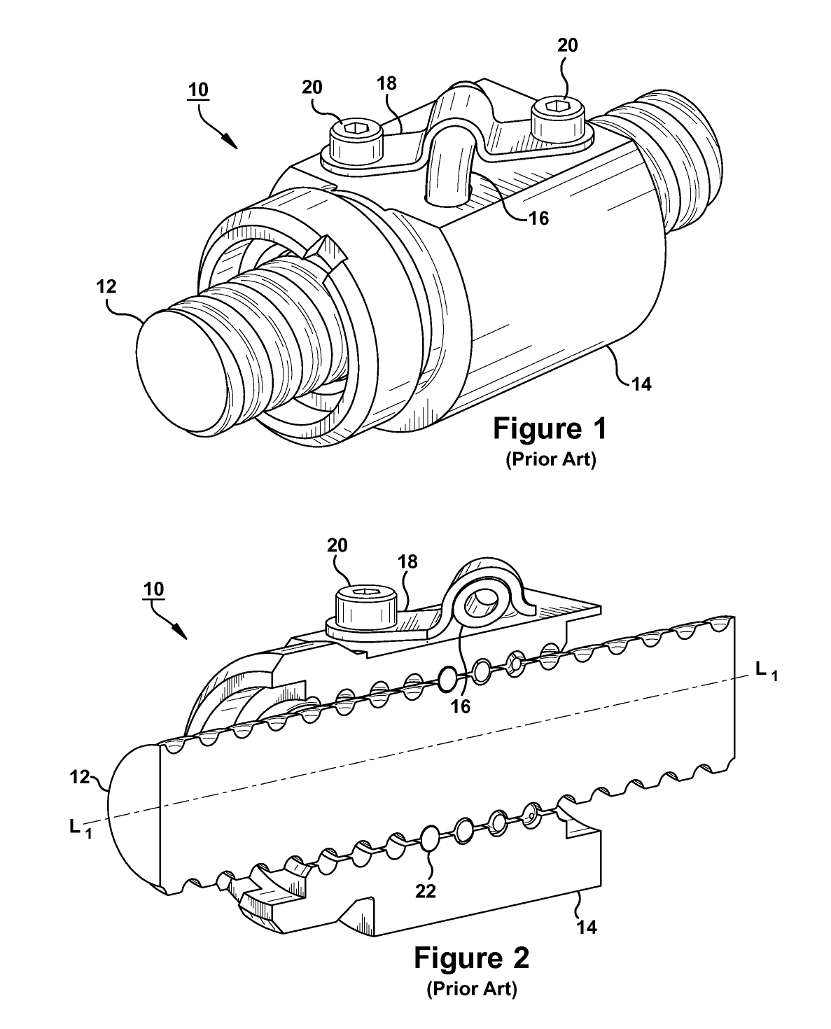

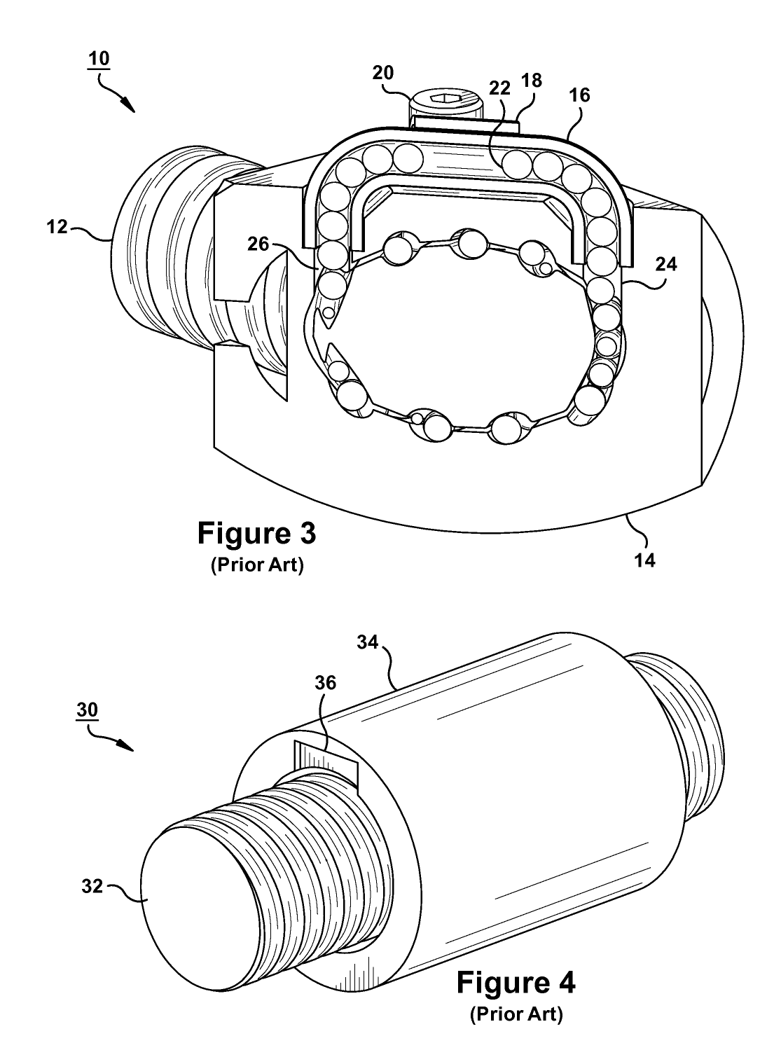

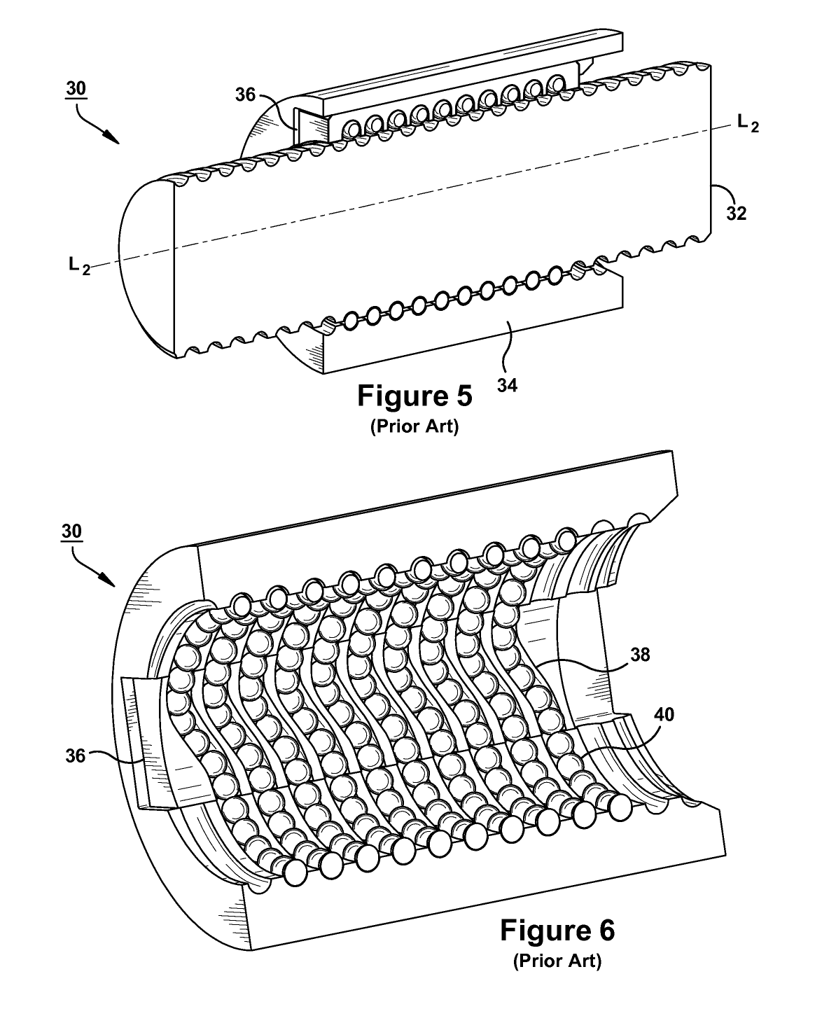

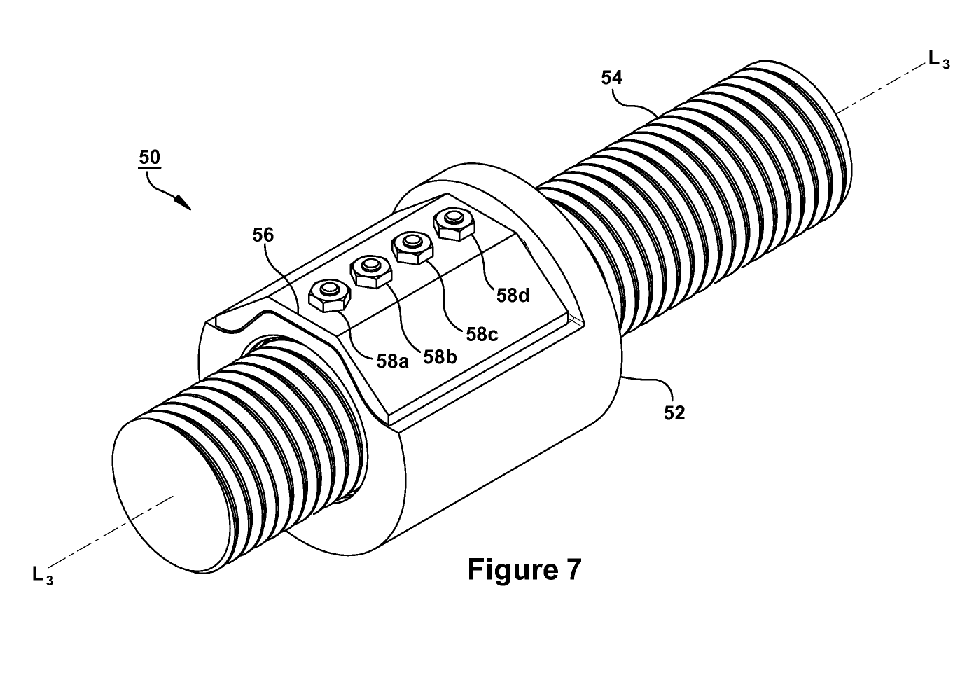

This inventive yoke style deflector has many new features. Typical yoke style deflectors include the usage of external tubes and clamps similar to the ball bearing assemblies shown in prior art FIGS. 1-3. The inventive assembly eliminates the need for individual external tube for each ball set (circuit of balls), thus eliminating parts and potential failure points. Internal return styles as seen in prior art FIGS. 4-6 have less parts but require the balls to travel over the ball screw land. Such an orientation creates potential pinch points and is very subjective to side loads causing the balls to jam between the ball nut and ball screw. The present invention has at least some bearing balls always contained between the ball nut, ball screw and cap without the use of return tubes. During the inventive recirculation process, the bearing balls are removed from the loaded path and transferred away from the screw into the ball nut body. The bearing balls are not required to make any direction changes via an internal return, over the ball screw, as seen in prior art FIG. 6.

In an exemplary embodiment, a ball screw assembly has a bearing ball recirculation arrangement. The assembly includes a ball screw, a nut body, at least one set of bearing balls, at least one cap, and at least two yolk deflectors attached to the nut body. The nut body is in threaded engagement with the ball screw, wherein one of the ball screw and the nut body is rotationally fixed relative the other. The at least one set of bearing balls is disposed to travel between the ball screw and the nut body in a load bearing path. The at least one cap has a recessed channel at least partially defining a return path for bearing balls from one end of the load bearing path to another end of the load bearing path. The at least one of the two yolk deflectors defines a contact surface to engage bearing balls exiting or entering the return path.

In an exemplary embodiment, a ball screw assembly has a closed path for bearing balls. The assembly includes a ball screw, a nut body in threaded engagement with the ball screw, a cap secured to the nut, and two yolks secured between the ball screw and the nut body. The outer surface of the nut body has a recessed channel at least partially defining a length of a return path. One of the two yolks defines an engaging surface to contact bearing balls entering the return path and the other of the two yolks defines an engaging surface to contact bearing balls exiting the return path.

In an exemplary embodiment, one yolk deflector may have an engagement surface at the beginning of a return path, and a second yolk deflector may have an engagement surface at the end of the return path.

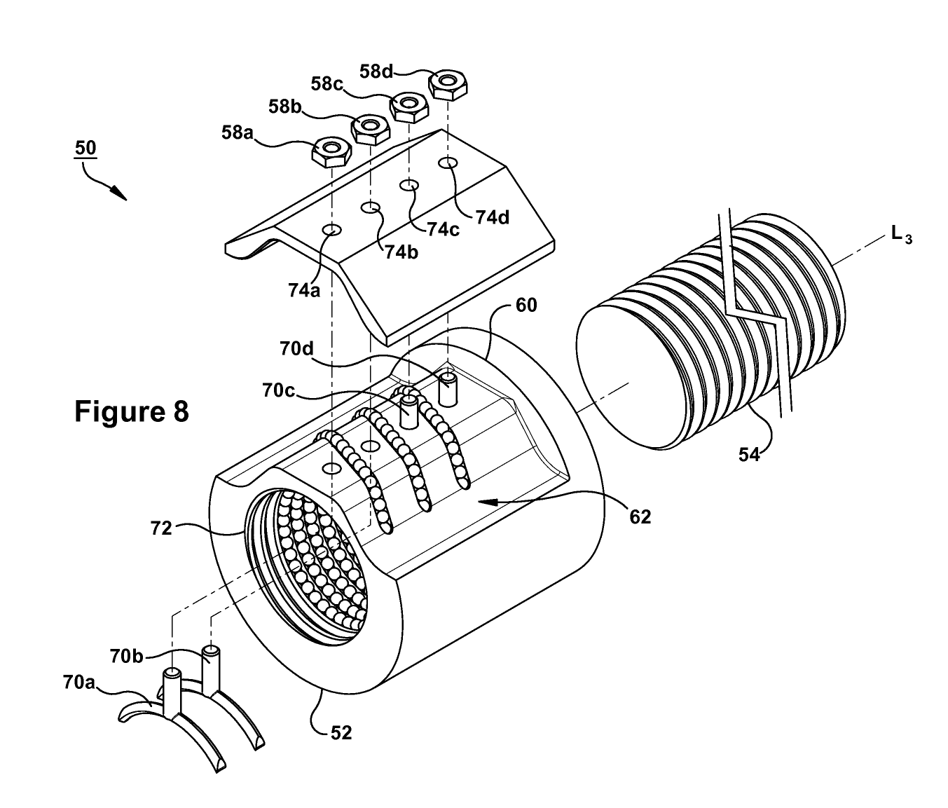

Referring now to the drawings, an embodiment on the invention having a single recirculation path is shown in FIGS. 7-11. The illustrated embodiment is for exemplary purposes only and should not be interpreted to limit the invention in any way. FIG. 7 is a perspective view of an exemplary embodiment of a ball screw assembly 50. The exemplary ball screw assembly 50 includes a nut body 52 positioned on a screw shaft 54 and, in an exemplary application, prohibited from rotational movement by structure (not shown). The nut body 52 is in threaded engagement with the ball screw, so as to move linearly along the longitudinal axis L₃ of the screw 54. A cap 56 is secured in place by mechanical fasteners 58a, 58b, 58c, 58d to an exposed and threaded post of one or more yolk deflectors 70a, 70b, 70c, 70d, as best seen in FIG. 9. In a secured position, the underside of the cap 56 rests within a recess 60 on an outer surface 62 of the nut 52, as best seen in FIG. 8. Two or more caps may be used in the practice of the invention.

A partially exploded assembly view of the ball screw assembly 50 is shown in FIG. 8. In this view, the cap 56 is shown removed from the assembly 50, as is two of the four yolk deflectors 70a, 70b. Two yolk deflectors 70c, 70d are shown in the assembly and partially under the nut body 52. The recess 60 in which the cap 56 rests in an assembled position is now visible. Within the recess 60 and within the right side aperture 72 of the nut body 52, some bearing balls are visible. In the exemplary embodiment shown, three sets of bearing balls 80a, 80b, 80c are included in the ball screw assembly. In the practice of the invention, at least one set of bearing balls is disposed to travel between the ball screw 54 and the nut body 52 in a load bearing path, as shown within aperture 72. In the exemplary embodiment shown, the three sets of bearing balls 80a, 80b, 80c also travel in a return path, as shown in the recess 60 of the nut body 52 (see FIG. 8). The return path may be at least partially defined by a recessed channel 90a, 90b, 90c of the nut body 52 (see FIG. 11), and also may be at least partially defined by the recessed channel 92a, 92b, 92c of the cap 56 (see FIG. 9). As illustrated, the recessed channel 90a, 90b, 90c of the nut body 52 and the recessed channel 92a, 92b, 92c of the cap 56 are cooperatively shaped to define a length of the return path. Discussed herein, each cooperatively shaped return path has various directions, including a horizontal path.

Additional views of the ball screw assembly 50 in various assembly positions are included in FIGS. 9-11. FIG. 9 is a partially exploded cross-sectional assembly view of the ball screw assembly 50. The sectional view is along the longitudinal axis L₃ of the screw 54, which is not shown. The underside of the cap 56 is visible, as are the three recess channels 92a, 92b, 92c which partially form the return path for three sets of ball bearings 80a, 80b, 80c. With two of the yolk deflectors 70a, 70b removed and two of the yolk deflectors 70c, 70d removed, the assembly position of the yolk deflectors is apparent relative certain other components. For example, the yolk deflectors are positioned within the internal female threads of the nut body 52 and the external male threads of the screw 54. Two of the four holes 76a, 76b within the nut body for insertion of the post of the yolk deflector are also exposed.

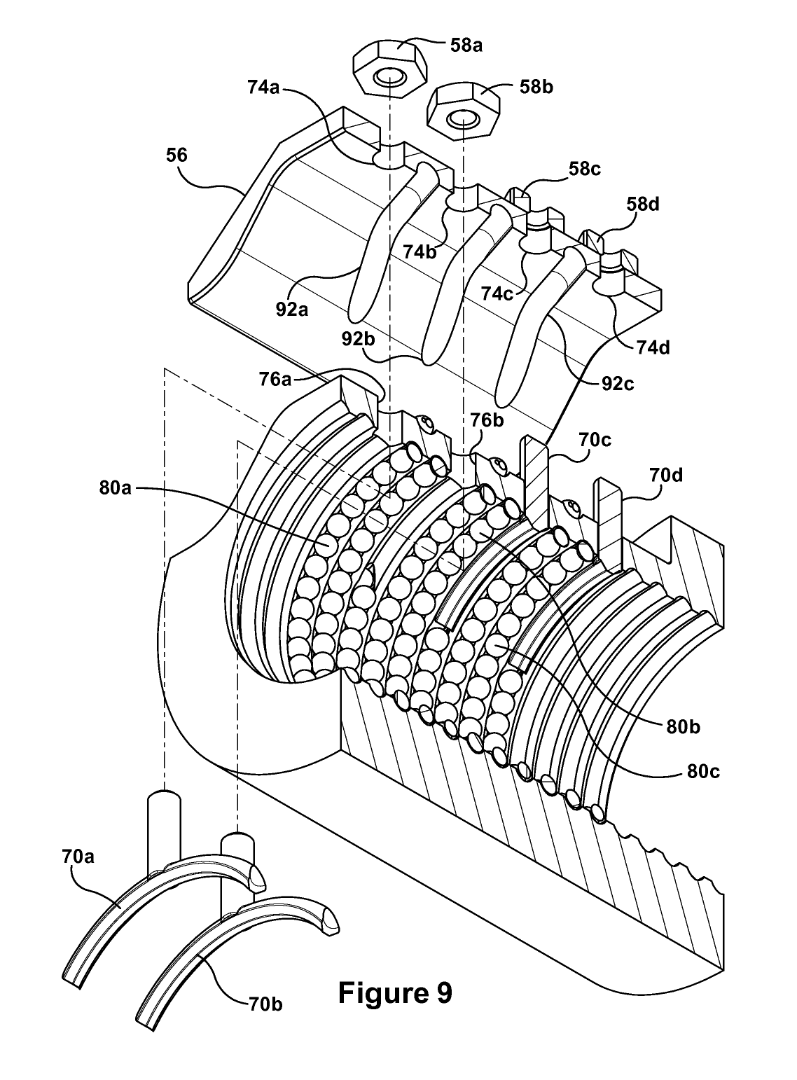

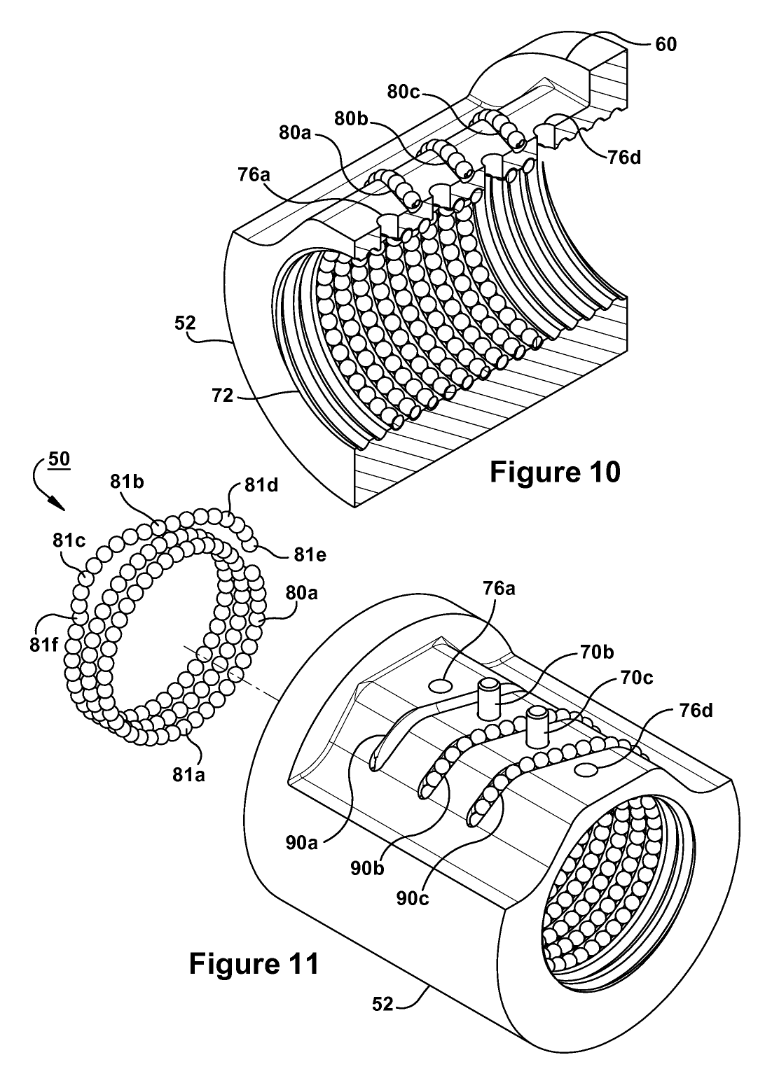

Referring now to FIG. 10, a perspective cross-sectional view of the nut body 52 of is shown along the longitudinal axis L₃ of the screw, which is also the longitudinal axis of the ball nut. All three ball bearing sets 80a, 80b, 80c are shown in an installed and operable condition. Within the nut body, the bearing sets 80a, 80b, 80c are operational in a side-by-side condition around the circumference of the screw 54 (not shown). The balls may move in either direction, clockwise or counterclockwise relative the screw, depending on the rotational direction of the rotating part, either the ball nut body 52 or the screw 54. The individual balls of each set 80a, 80b, 80c generally remain in a side-by-side condition with at least one other ball, except when exiting the load bearing path, i.e., the path in which positioned between the nut body 52 and the screw 54, and within the return path. In FIG. 10, balls are illustrated in the load bearing path, i.e., inside the nut body 52, and in the return path, either within the nut body or outside the nut body.

In FIG. 11, a perspective partially exploded assembly view of the ball screw assembly is shown with the screw 54, the cap 56 and the yoke deflectors 70a, 70d on each end of the assembly 50 removed. FIG. 11 also shows one set of ball bearings 80a removed from the assembly, and in an operational orientation. As shown, the set 80a can be generally discussed in groups. The balls 81a within the load bearing path generally form three rings around the screw. The balls in the return path must be positioned to travel to exit at one end of the load bearing path and to enter at the other end of the load bearing path. For example, in FIG. 11 the balls 81e, 81f enter and exit the return path in positions moving upward or downward in close to vertical movement. Any ball fully within the return path is in either a horizontal motion 81b, or in curved motions 81c, 81d upward or downward. The return path of the exemplary ball screw assembly is for example only and the invention may be practiced with return paths and load bearing paths of other geometry.

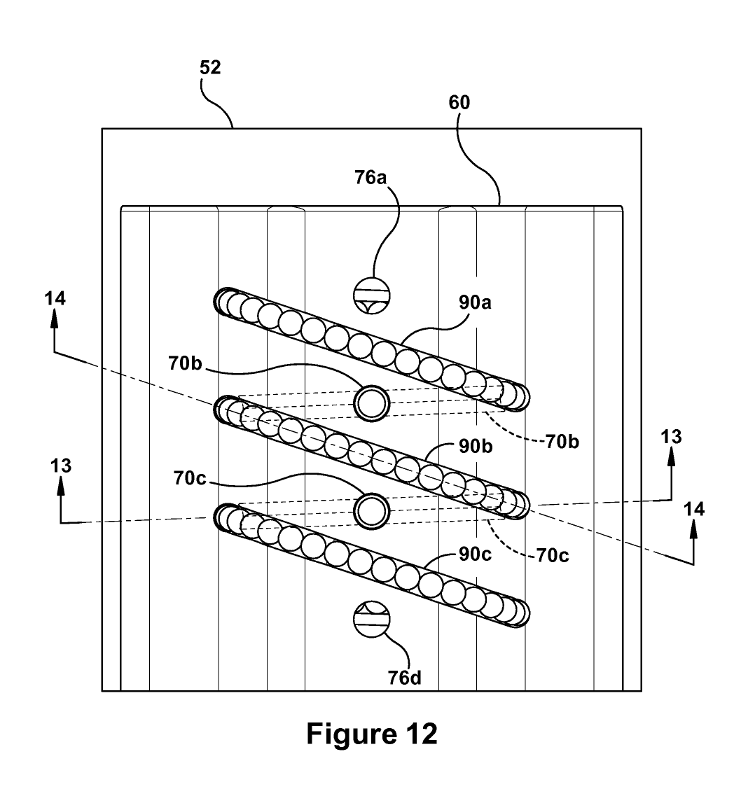

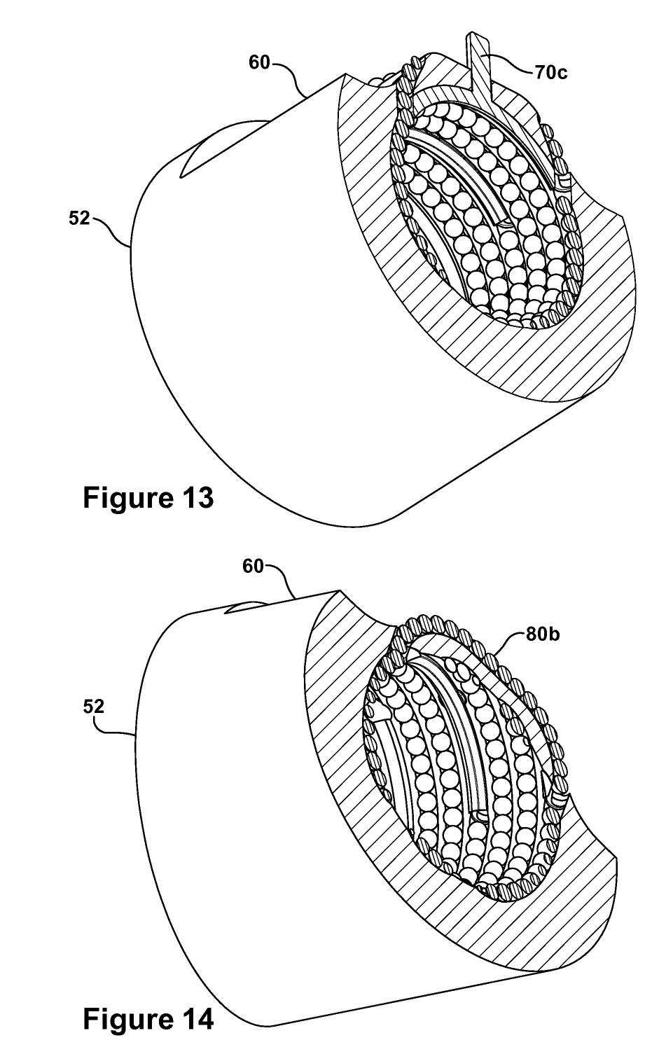

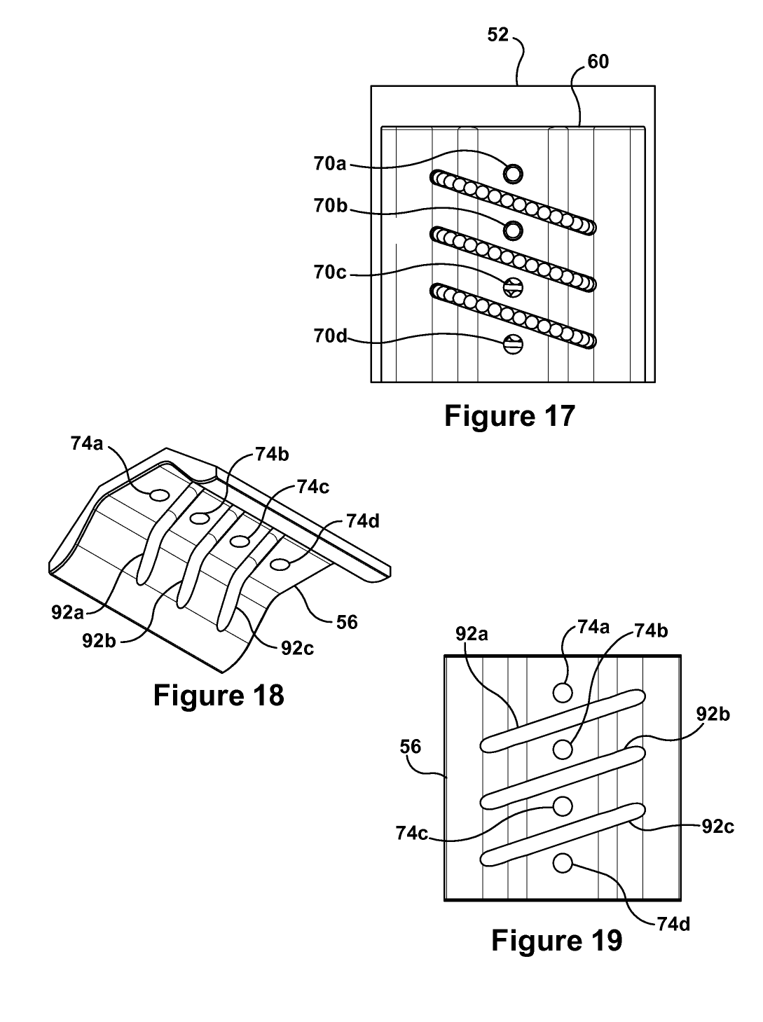

An exemplary arrangement of the nut body, the yolk deflectors and the set of ball bearings is shown in FIGS. 12-14. A top view of the ball screw assembly 50 is shown in FIG. 12 with the screw, cap and two yoke deflectors removed. A view with a similar arrangement is shown in FIG. 17. Returning to FIG. 12, companion views are included in FIGS. 13 and 14. FIG. 13 is a cross-sectional view of the ball screw assembly along the lines 13-13 of FIG. 12, and FIG. 14 is a cross-sectional view of the ball screw assembly 50 along the lines 14-14 of FIG. 12.

In regard to FIG. 13, the sectional view is along the third yolk deflector 70c. In the illustrated embodiment, the yolk deflectors 70a, 70b, 70c, 70d are disposed in a generally perpendicular position to the longitudinal axis L₃ of the screw 54. As seen in FIGS. 12 and 14, the center set of ball bearing travels between yolk deflector 70b and yolk deflector 70c when within the return path, which is partially formed by recess 90b in the nut body and recess 92b in the cap (not shown).

Among other features in the practice of the invention, the number of balls bearing sets and the number of yolk deflectors may vary. In an embodiment, the number of yolk deflectors will be one more than the number of ball bearing sets. Discussed herein, the number of balls bearing sets 80a, 80b, 80c, i.e., three, is one less than the number of yolk deflectors 70a, 70b, 70c, i.e., four, as for each load bearing path, as a different yolk deflector is positioned at the exit and entrance. For example, yolk deflector 70a is positioned at one end of the loading bearing path for the first ball bearing set 80a, and yolk deflector 70b is positioned at the other end of the loading bearing path for the same ball bearing set 80a. Likewise, yolk deflector 70b is positioned at one end of the loading bearing path for the center ball bearing set 80b, and yolk deflector 70c is positioned at the other end of the loading bearing path for the same ball bearing set 80b.

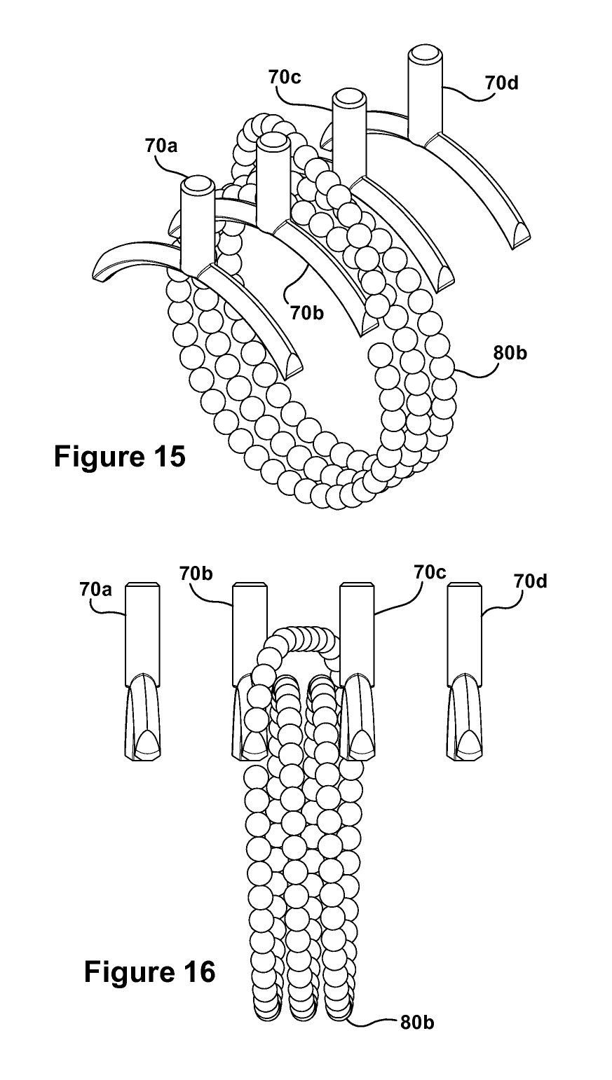

This specific arrangement of the center ball bearing set 80b is shown clearly in FIGS. 15 and 16. Referring to FIG. 15, a perspective view of the ball screw assembly 50 is shown with only the center set of bearing balls 80b and the yoke deflectors 70a, 70b, 70c, 70d included. A front view of the same arrangement is shown in FIG. 16. As discussed herein, the arrangement illustrates how the number of yolk deflectors is one more than the number of ball bearing sets in the illustrated embodiment, as for each load bearing path, a different yolk deflector is positioned at the exit and entrance. For example, yolk deflector 70b is positioned at one end of the loading bearing path for the center ball bearing set 80b, and yolk deflector 70c is positioned at the other end of the loading bearing path for the same ball bearing set 80b.

Additional views of the exemplary cap 56 are shown in FIGS. 18 and 19. A bottom perspective view of the cap 56 is shown in FIG. 18 and a bottom view of the cap 56 is shown in FIG. 19. The channels 92a, 92b, 92c which form a portion of the return paths are shown on the underside of the cap 56. As discussed herein, the cap 56 is cooperatively shaped to nest into the recess 60 on the top side of the nut body 52.

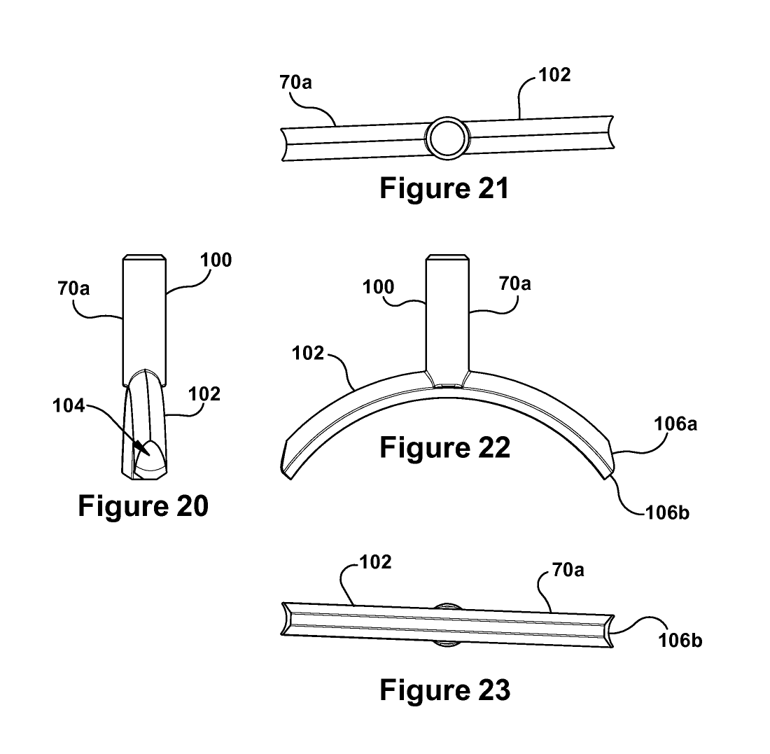

The yolk deflector will now be discussed in additional detail. The yolk deflector will be discussed in terms of the first yolk deflector of ball screw assembly 50. FIGS. 20-23 shown various views of the exemplary first yoke deflector 70a of the exemplary assembly 50. In one embodiment of the invention, at least two yolk deflectors are attached to the nut body, and at least one of the two yolk deflectors defines a surface to engage bearing balls exiting or entering the return path. The surface may defect the ball so as to change the travel path of the ball, either entering or exiting the return path or entering or exiting the load bearing path. The surface may be divided into two surfaces to each change the travel path of the ball, depending on the clockwise or counterclockwise direction of the ball. As such, at least one of the at least two yolk deflectors defines at least a portion of the return path. The other of the two yolk deflectors may define an engaging surface to contact bearing balls exiting the return path. The yolk deflectors are secured between the screw and the nut body in a non-intrusive arrangement to allow relative rotational movement between the screw and the nut body.

In the exemplary assembly illustrated, the yolk deflector 70a an integral, i.e., one-piece, deflector and may be formed from any suitable material, such as for example, steel. At least two yolk deflectors are identical, and in the exemplary embodiment discussed, the four yolk deflectors 70a, 70b, 70c, 70d are identical. The yolk deflector 70a has a port 100 protruding from a body 102. The body 102 is curved relative to the center point of the ball screw 54. As such, the body 102 fits securely between the internal female threads of the nut body 52 and the external male threads of the screw 54. The port 100 is shaped to insert through two cooperatively-shaped and aligned holes, a hole 76a in the nut body and a hole 74a in the cap 56. The end of the port 100 protrudes clear of the hole in the cap, and may be secured, for example, if threaded, secured by a fastener 58a, as shown in FIG. 7.

As discussed herein, a yolk deflector forms part of the beginning of the return path and another yolk deflector forms part of the end of the same return path. The deflecting surface 104 is generally concave and cooperatively shaped to engage a ball bearing. The exemplary deflecting surface illustrated in FIGS. 20-23 has two portions, a larger engaging top surface 106a and a smaller deflecting bottom surface 106b. Each of surfaces 106a, 106b, may deflect a ball bearing in a different direction depending on the clockwise or counterclockwise direction of the ball bearing. In some embodiments, only the bottom surface 106b may change the direction of travel of the ball bearing. In the practice of the invention, the deflecting surface 104 may vary in shape, and may be formed by more or less than two surfaces.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, software, hardware, control logic, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A ball screw assembly having a bearing ball recirculation arrangement, the assembly comprising:
a ball screw;
a nut body in threaded engagement with the ball screw, wherein one of the ball screw and the nut body is rotationally fixed relative the other;
at least one set of bearing balls disposed to travel between the ball screw and the nut body in a load bearing path;
at least one cap having a recessed channel at least partially defining a return path for bearing balls from one end of the load bearing path to another end of the load bearing path; and
at least two yolk deflectors attached to the nut body, wherein at least one of the two yolk deflectors defines a deflecting surface to engage bearing balls exiting or entering the return path.

2. The ball screw assembly of claim 1 wherein the nut body has a recessed channel at least partially defining a return path for bearing balls.

3. The ball screw assembly of claim 2 wherein the recessed channel of the nut body and the recessed channel of the at least one cap are cooperatively shaped to define a length of the return path.

4. The ball screw assembly of claim 3 wherein the recessed channel of the nut body and the recessed channel define a horizontal length of the return path.

5. The ball screw assembly of claim 1 wherein at least one of the at least two yolk deflectors defines at least a portion of the return path.

6. The ball screw assembly of claim 5 wherein at least one of the at least two yolk deflectors defines a concave deflecting surface.

7. The ball screw assembly of claim 1 wherein at least one of the at least two yolk deflectors are integral.

8. The ball screw assembly of claim 1 wherein the at least two yolk deflectors are identical.

9. The ball screw assembly of claim 1 wherein at least one of the at least two yolk deflectors has a body portion which is curved relative to the center point of the ball screw.

10. The ball screw assembly of claim 9 wherein at least one of the at least two yolk deflectors has a port protruding from the body portion and through a cooperatively-shaped and aligned hole in the at least one cap.

11. A ball screw assembly having a closed path for bearing balls, the assembly comprising:
a ball screw;
a nut body in threaded engagement with the ball screw, the outer surface of the nut body having a recessed channel at least partially defining a length of a return path;
a cap secured to the nut, and
two yolks, each of the two yolks secured between the ball screw and the nut body;
wherein one of the two yolks defines an engaging surface to contact bearing balls entering the return path and the other of the two yolks defines an engaging surface to contact bearing balls exiting the return path.

12. The ball screw assembly of claim 11 wherein one of the ball screw and the nut body is rotationally fixed relative the other of the ball screw and the nut body.

13. The ball screw assembly of claim 11 wherein the cap has a recessed channel at least partially defining a return path for bearing balls.

14. The ball screw assembly of claim 13 wherein the recessed channel of the nut body and the recessed channel of cap are cooperatively shaped to define a length of the return path.

15. The ball screw assembly of claim 14 wherein a length of the return path is horizontal.

16. The ball screw assembly of claim 11 wherein at least one of the engaging surfaces is concave.

17. The ball screw assembly of claim 11 wherein at least one of the two yolks are integral.

18. The ball screw assembly of claim 11 wherein the two yolks are identical.

19. The ball screw assembly of claim 11 wherein each of the two yolks has a body curved relative to the circumference of the ball screw.

20. The ball screw assembly of claim 19 wherein each of the two yolks has a port protruding from the body and through a cooperatively-shaped and aligned hole in the cap.
